(19) United States
(12) Patent Application Publication
(10) Pub. No.: US 2026/0072769 A1
(43) Pub. Date: Mar. 12, 2026

(54) Api Management System, Api Management Device, And Storage Medium Storing Api Management Program

(71) Applicant: DENSO CORPORATION, Kariya-city (JP)

(72) Inventors: Kunimitsu HANDA, Kariya-city (JP); Satoshi NIWA, Kariya-city (JP); Yoshitaka TANEMURA, Kariya-city (JP)

(21) Appl. No.: 19/387,459

(22) Filed: Nov. 12, 2025

Related U.S. Application Data
(63) Continuation of application No. PCT/JP2024/017281, filed on May 9, 2024.

(30) Foreign Application Priority Data
May 16, 2023 (JP) 2023-080844

(51) Int. Cl. G06F 9/54

(52) U.S. Cl. CPC G06F 9/544

(57) ABSTRACT

An application programing interface management system comprises: a server; and an in-vehicle application programing interface management device. The server stores attribute information that associates a data attribute of vehicle data of each vehicle with a vehicle attribute that identifies a vehicle having the data attribute, stores the vehicle attribute of each vehicle, selects the data attribute valid for each vehicle, and provides the data attribute to the application programing interface management device. The application programing interface management device stores the data attribute that is valid and provided from the server, and selects the vehicle data used by an application program installed in the vehicle, and provides the vehicle data to the application program.

### CROSS REFERENCE TO RELATED APPLICATIONS

The present application is a continuation application of International Patent Application No. PCT/JP2024/017281 filed on May 9, 2024, which designated the U.S. and claims the benefit of priority from Japanese Patent Application No. 2023-080844 filed on May 16, 2023. The entire disclosures of all of the above applications are incorporated herein by reference.

### TECHNICAL FIELD

The present disclosure relates to an application programing interface (API) technology that provides appropriate vehicle data to an application program. The API is an abbreviation for Application Programming Interface.

### BACKGROUND

A technology of dividing an input document into paragraphs and selecting a vertex for each paragraph has been known as a comparative example. Each vertex is assigned a vertex name and a vertex attribute. An edge connecting the vertices is selected based on the vertex attribute. In such a manner, when the attribute is assigned to the vertex, it is possible to appropriately execute the process based on the vertex attribute.

Even when an in-vehicle application program using the vehicle data is created, it is required to generate the application program using appropriate vehicle data for each vehicle based on the data attributes of the vehicle data.

However, the data attributes of the vehicle data may differ depending on the vehicle attributes for each vehicle, such as the vehicle manufacturer and drive system. Accordingly, the creator of the application program needs to create the application program by selecting appropriate vehicle data having a valid data attribute for each vehicle based on the vehicle attributes.

### SUMMARY

According to an aspect of the present disclosure, an application programing interface management system comprises: a server; and an in-vehicle application programing interface management device. The server includes a storage that stores attribute information that associates a data attribute of vehicle data with a vehicle attribute that identifies a vehicle having the data attribute and stores the vehicle attribute of each vehicle, and selects the data attribute valid for each vehicle from the attribute information, and provides the data attribute to the application programing interface management device. The application programing interface management device includes a valid attribute storage configured to store the data attribute that is valid and provided from the server in accordance with a vehicle in which the application programing interface management device is mounted; and at least one of (i) a circuit and (ii) a processor with a memory storing computer program code executable by the processor, the at least one of the circuit and the processor configured to cause the application programing interface management device to select the vehicle data used by an application program installed in the vehicle, and provide the vehicle data to the application program.

### BRIEF DESCRIPTION OF THE DRAWINGS

FIG. 1 is a block diagram illustrating a configuration of an API management system according to a first embodiment.

FIG. 2 is a block diagram showing a hardware configuration of a server and an API management device.

FIG. 3 is an explanatory diagram showing a data model of vehicle data.

FIG. 4 is an explanatory diagram showing contents of end data attributes in a data model.

FIG. 5 is an explanatory diagram showing contents of data attributes of a branch in the data model.

FIG. 6 is an explanatory diagram showing contents of vehicle attributes.

FIG. 7 is an explanatory diagram showing valid or invalid data attributes for each vehicle.

FIG. 8 is a sequence diagram showing an API management process of the API management system.

FIG. 9 is an explanatory diagram showing a process of providing valid data attributes from the server to a vehicle.

FIG. 10 is an explanatory diagram showing a process in which an application program calls vehicle data.

FIG. 11 is a block diagram illustrating a configuration of an in-vehicle API management device according to a second embodiment.

FIG. 12 is a block diagram showing a hardware configuration of the API management device.

FIG. 13 is a sequence diagram showing an API management process of the API management device.

FIG. 14 is an explanatory diagram showing a process in which the application program calls vehicle data.

### DETAILED DESCRIPTION

As a result of detailed studies by the inventors, there is a difficulty that, in order to select appropriate vehicle data having the valid data attribute for each vehicle having different vehicle characteristics, it takes a long time for the program creator to work and errors may occur in selecting the vehicle data.

In particular, for a creator who is not skilled in creating an in-vehicle application program, it takes a long time to select appropriate vehicle data, and errors in vehicle data selection are likely to occur.

One aspect of the present disclosure provides an API technology that provides appropriate vehicle data having valid data attributes for each vehicle to an application program.

According to one aspect of the present disclosure, an API management system includes a server and an in-vehicle API management device.

The server includes an attribute information storage unit, a vehicle attribute storage unit, and a valid attribute determination unit.

An attribute information storage unit stores attribute information that associates a data attribute of vehicle data of each of multiple vehicles with a vehicle attribute that identifies the vehicle having the data attribute. The vehicle attribute storage unit stores the vehicle attribute of each vehicle. The valid attribute determination unit selects a valid data attribute for each vehicle from the attribute information based on the attribute information stored by the attribute information storage unit and the vehicle attribute stored by the vehicle attribute storage unit, and provides the valid data attribute to the API management device.

The API management device includes the valid attribute storage unit and a data provision unit.

The valid attribute storage unit stores the valid data attribute provided by the server in accordance with the vehicle equipped with the API management device. The data provision unit selects the vehicle data used by the application program installed in the vehicle based on the data attribute stored by the valid attribute storage unit and provides the vehicle data to the application program.

According to another aspect of the present disclosure, an API management program is installed in a server that causes a computer to provide a data attribute valid for a vehicle to the API management device. The API management device selects the vehicle data used by the application program installed in the vehicle based on the data attribute valid for the vehicle and provides the vehicle data to the application program. The API management program causes the computer to function as an attribute information storage unit, a vehicle attribute storage unit, and a valid attribute determination unit. Each function of the attribute information storage unit, the vehicle attribute storage unit, and the valid attribute determination unit is the same as that of the server of the API management system described above.

According to another aspect of the present disclosure, an API management program is an API management program installed in an in-vehicle API management device, and functions as a valid attribute storage unit and a data provision unit. Each function of the valid attribute storage unit and the data provision unit is the same as the API management device of the API management system described above.

According to another aspect of the present disclosure, an in-vehicle API management device includes an attribute information storage unit, a vehicle attribute storage unit, a valid attribute determination unit, and a data provision unit.

An API management program according to another aspect of the present disclosure is an API management program installed in this API management device, and causes a computer to function as an attribute information storage unit, a vehicle attribute storage unit, a valid attribute determination unit, and a data provision unit.

The attribute information storage unit stores attribute information that associates a data attribute of vehicle data of each of multiple vehicles including a subject vehicle with a vehicle attribute that identifies the vehicle having the data attribute. The vehicle attribute storage unit stores the vehicle attribute of the subject vehicle.

The valid attribute determination unit determines and selects a valid data attribute for the subject vehicle from the attribute information based on the attribute information stored by the attribute information storage unit and the vehicle attribute stored by the vehicle attribute storage unit. The data provision unit selects the vehicle data used by the application program installed in the vehicle based on the data attribute determined to be valid by the valid attribute determination unit, and provides the vehicle data to the application program.

According to such a configuration, it is possible to implement an API that provides appropriate vehicle data having valid data attributes for each vehicle to the application program based on the vehicle attribute that identifies the vehicle.

Accordingly, the creator of the application program does not need to select appropriate vehicle data having valid data attributes for the vehicle. That is, it is possible to shorten the time required to create the application program and prevent errors in selecting vehicle data.

Hereinafter, embodiments of the present disclosure will be described with reference to the drawings.

### 1. First Embodiment

### (1-1. Configuration)

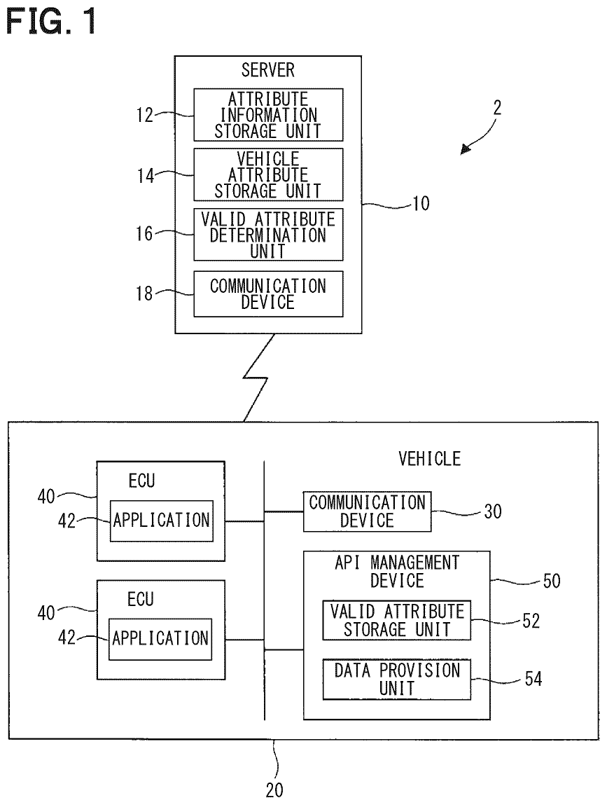

An API management system 2 shown in FIG. 1 includes a server 10 and an API management device 50 mounted in a vehicle 20.

The server 10 includes an attribute information storage unit 12, a vehicle attribute storage unit 14, a valid attribute determination unit 16, and a communication device 18. The server 10 communicates with the vehicle 20 via the network the like by the communication device 18. Functions executed by the attribute information storage unit 12, the vehicle attribute storage unit 14, and the valid attribute determination unit 16 of the server 10 will be described later.

The vehicle 20 includes a communication device 30, multiple ECUs 40, and the API management device 50. The ECU is an abbreviation for Electronic Control Unit. The vehicle 20 communicates with the server 10 via a network or the like by the communication device 30.

The ECU 40 is equipped with an application program 42 that executes vehicle control and the like. Hereinafter, the application program may also be referred to as an application.

The API management device 50 includes a valid attribute storage unit 52 and a data provision unit 54. Functions executed by the valid attribute storage unit 52 and the data provision unit 54 of the API management device 50 will be described later.

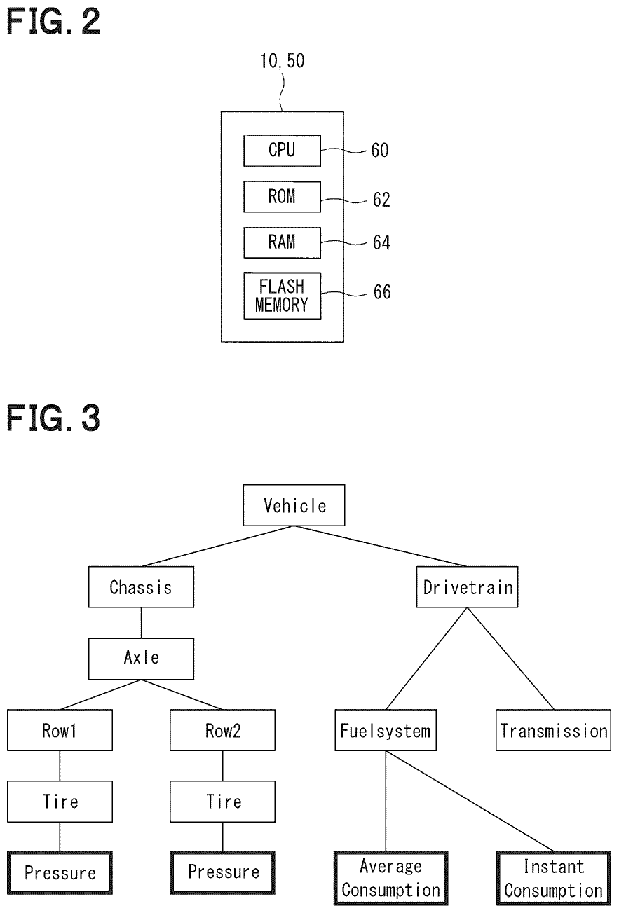

As shown in FIG. 2, each of the server 10 and the API management device 50 includes a CPU 60, a ROM 62, a RAM 64, a flash memory 66, and the like as hardware configurations. Various functions of the server 10 and the API management device 50 are implemented by the CPU 60 executing programs stored in a non-transitory tangible storage medium such as the ROM 62. Further, by executing this program, a method corresponding to the program is executed.

The attribute information storage unit 12 of the server 10 described above stores, as the multiple vehicles 20, attribute information having (1) a data attribute representing an attribute of the vehicle data and (2) a vehicle attribute identifying the vehicle 20, for all vehicles 20 in the world. The vehicle attributes may be stored in association with data attributes valid for the vehicle 20.

As the vehicle data, data related to the vehicle 20, people related to the vehicle 20, data about the peripheral environment of the vehicle 20, and the like are assumed.

The data related to the vehicle 20 may include tire air pressure, average fuel consumption, instantaneous fuel consumption, vehicle speed, acceleration, wiper operating state, and the like. The people related to the vehicle 20 may include the occupant of the vehicle 20, the owner of the vehicle 20, and the like. The data of the peripheral environment of the vehicle 20 may include recognition results of road signs and the like.

### (1) Data Attributes

In the present embodiment, a hierarchical data model as shown in FIG. 3 is assumed for the vehicle data of the vehicle 20. For information on the data model, the explanation of VSS as provided on the Internet (URL: https://covesa.github.io/vehicle_signal_specification/) may be referred to, for example. The VSS is an abbreviation for Vehicle Signal Specification.

The end vehicle data surrounded by thick lines in a hierarchical structure shown in FIG. 3 has data values such as “Pressure”, “Average Consumption”, and “Instant Consumption”. Pressure represents tire pressure, Average Consumption represents the average fuel consumption, and Instant Consumption represents the instantaneous fuel consumption.

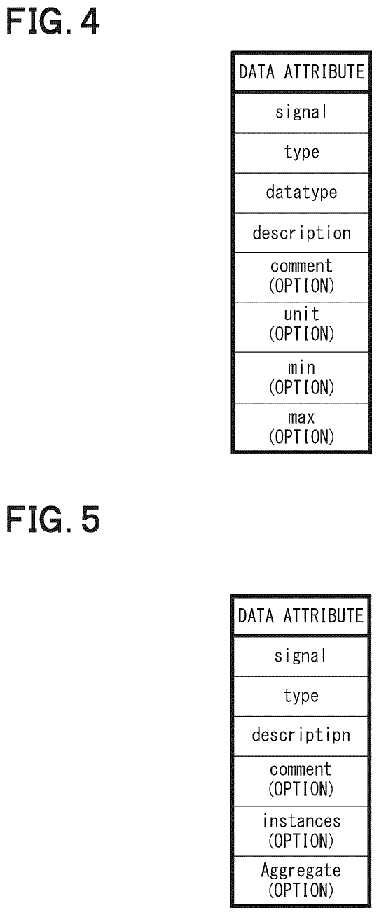

As shown in FIG. 4, the vehicle data at the end of the hierarchical structure has data attributes represented by items of the signal, type, datatype, description, comment, min, and max.

The “signal” represents a data name. The “type” represents a category of vehicle data such as sensors, actuators, etc. of the vehicle 20. The “datatype” represents a data type such as integer, floating point, character, etc. The “description” represents a description of the vehicle data. The “comment” is optional and represents additional information about the vehicle data. The “min” is optional and represents the minimum data value of the vehicle data. The “max” is optional and represents the maximum data value of the vehicle data.

Further, as shown in FIG. 5, the vehicle data of the branch that is the vehicle data other than “Vehicle” and the end surrounded by the thick line in FIG. 3 has data attributes represented by each item of signal, type, description, comment, instances, and aggregation.

The “signal” represents the data name. The “type” indicates that this vehicle data is a branch in the data model shown in FIG. 3. The “description” represents a description of the vehicle data. The “comment” is optional and represents additional information about the vehicle data.

The “instances” is optional and lists two or more names of vehicle data hanging under this vehicle data in a sequential format. For example, in the case of “instances” of “axle” in FIG. 3, “row1” and “row2” are listed in the sequential format. In this description, the same vehicle data hangs under the axle in “row1” and “row2” respectively. In FIG. 3, the same vehicle data of “tire”hangs under “row1”and “row2”.

In such a manner, by setting “instances” as the data attribute of the branch, it is understood that the same vehicle data hang from “row1” and “row2” without checking the data attributes of “row1”and “row2”hanging under “axle”.

The “Aggregation” is optional and indicates, with “true” or “false”, whether the branch is meaningful only when it is handled simultaneously as a system.”

### (2) Vehicle Attributes

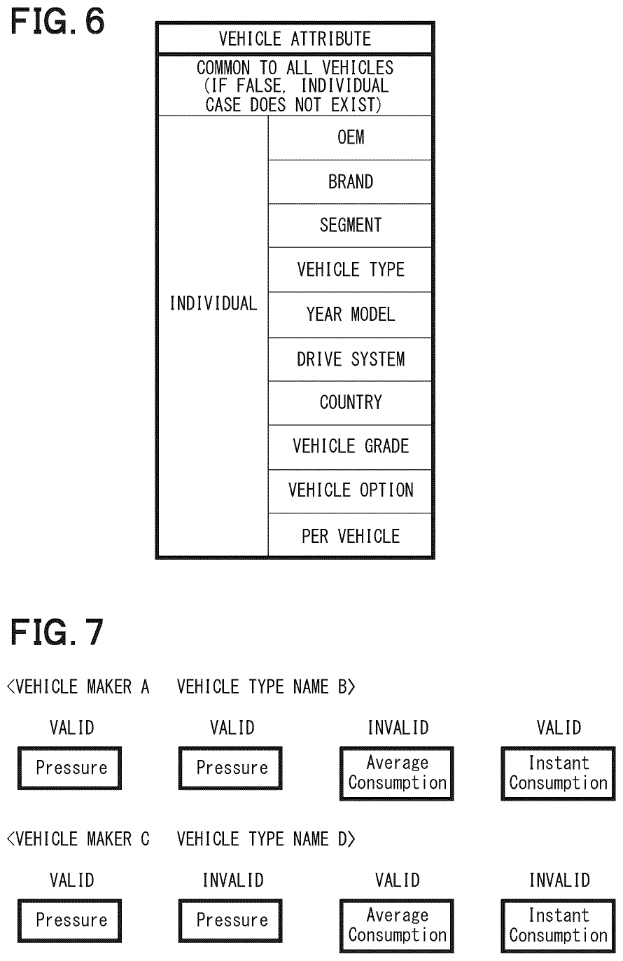

In the vehicle attributes of FIG. 6, “common to all vehicles” indicates whether the data attribute to which the vehicle attribute is associated is common and valid for all vehicles 20. A case of “true” indicates that the information is common to all vehicles 20, and the individual vehicle attributes described below are not described. A case of “false” indicates that it is not common to all vehicles 20, and individual vehicle attributes described below will be described.

The “OEM” of the vehicle attribute shown in FIG. 6 represents a vehicle manufacturer such as Toyota (registered trade mark) or Nissan (registered trade mark). The “brand” represents the brand of the vehicle 20 manufactured by the vehicle manufacturer. If the OEM is Toyota, Toyota or Lexus (registered trade mark) is listed as the brand. The “segment” represents whether the vehicle 20 is a sedan, an SUV, or the like. In the “vehicle type”, for example, when the “brand” is Toyota, Crown (registered trade mark), Prius (registered trade mark), and the like are described. In the “year model”, the release start year of the vehicle 20 is described.

In the “drive system”, Gasoline engines, HEVs, and the like are described. The HEV is an abbreviation for Hybrid Electric Vehicle. The “country” represents the country in which the vehicle 20 is used. The “vehicle grade” indicates, for example, differences in equipment and performance for the same vehicle model.

The “vehicle option” represents whether the vehicle data is vehicle data generated by the vehicle option provided by the vehicle manufacturer as “true” or “false”. For example, when a camera is added as a vehicle option, the image data captured by the camera is “true”.

The “per vehicle” is not the vehicle option, but represents vehicle data generated for each vehicle depending on the option provided by the dealer or the like.

The vehicle attributes may include, at least, the vehicle manufacturer, vehicle type, drive system, use country and grade, as information.

The vehicle attribute storage unit 14 of the server 10 stores, for all vehicles 20, vehicle attributes that identify the vehicle 20. The vehicle attribute storage unit 14 does not store the vehicle attribute of “common to all vehicles”described above.

The data attributes and vehicle attributes stored by the attribute information storage unit 12 and the vehicle attributes stored by the vehicle attribute storage unit 14 are changed and added by a terminal mounted in the server 10 or a terminal such as a dealer connected to the server 10 via the Internet or the like. Changes and additions of data attributes and vehicle attributes are performed, for example, in the following cases (1) and (2).
(1) A component such as a sensor mounted on the vehicle 20 is replaced by upgrading, or an optional device such as an in-vehicle camera provided by the vehicle manufacturer is added to the vehicle 20.
(2) The vehicle type is added.

The valid attribute determination unit 16 of the server 10 determines and selects the valid data attributes for each vehicle 20 based on the vehicle attributes of the attribute information stored by the attribute information storage unit 12 and the vehicle attributes stored by the vehicle attribute storage unit 14, and provides them to the API management device 50.

For example, as shown in FIG. 7, in the case of the vehicle 20 with a vehicle manufacturer A and a vehicle type name B, the “Pressure” of “Row1” and “Row2” and “Instant Consumption are valid as data attributes, but the “Average Consumption” is invalid. In the case of the vehicle 20 with a vehicle manufacturer C and a vehicle model name D, the “Pressure” of “Row1” and the “Average Consumption” are valid, but the “Pressure”of “Row2”and the “Instant Consumption”are invalid.

In cases of the following (1) and (2), for example, upon request from the vehicle 20 equipped with the API management device 50 or a terminal connected to the API management device 50, the valid attribute determination unit 16 provides a valid data attribute of the vehicle 20 to the API management device 50. The API management device 50 may be mounted in the vehicle 20 or removed from the vehicle 20 as long as it can communicate with the server 10.
(1) It is a case where the first valid data attribute is provided to the API management device 50.
(2) It is a case where the data attribute of the vehicle 20 is changed or added.

The valid attribute storage unit 52 of the API management device 50 stores valid data attributes provided from the server 10 in the vehicle 20 in which the API management device 50 is mounted.

When the application 42 calls the data name of the vehicle data, the data provision unit 54 acquires vehicle data corresponding to the corresponding data name, for example, from the ECU 40 and provides it to the application 42 based on the data name and the data attributes stored by the valid attribute storage unit 52.

The data name of the vehicle data called by the application 42 may be the name of a branch or the name of an end in the data model shown in FIG. 3. When the name of the branch is called, the data provision unit 54 provides the vehicle data of all ends hanging from the branch to the application 42.

### (1-2. Process)

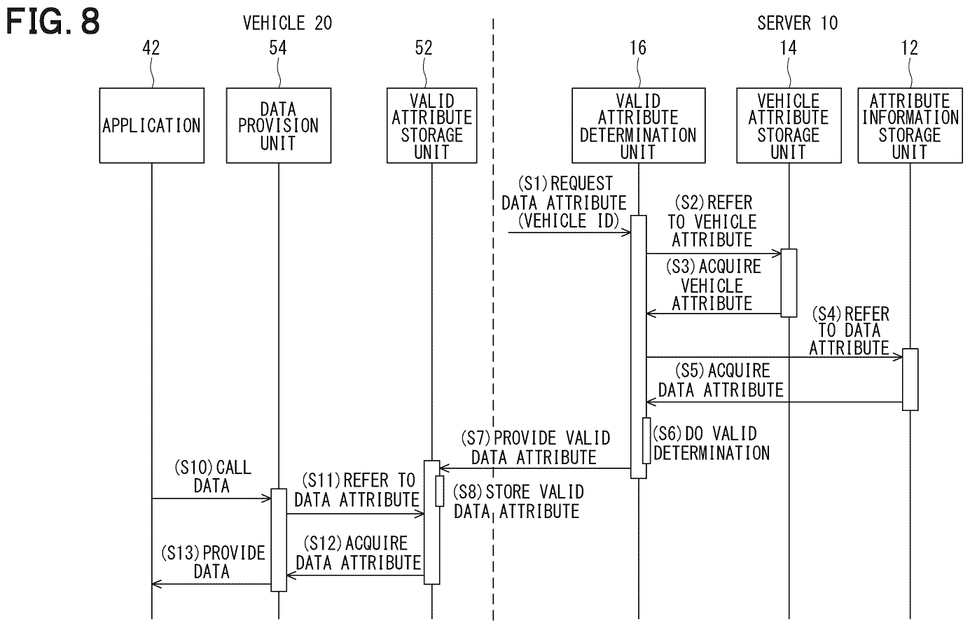

An API management process executed by the API management system 2 will be described with reference to FIGS. 8 to 10.

In FIG. 8, the data attribute provision processes in S1 to S8 are executed when the first valid data attribute is provided to the API management device 50 or when the data attribute of the vehicle 20 is changed or added.

Further, in FIG. 8, the processes of S10 to S13 are executed when the application 42 installed in the vehicle 20 calls the data name of the vehicle data.

### (1) Data Attribute Provision Process

In S1 of FIG. 8, the valid attribute determination unit 16 of the server 10 accepts a request to provide the valid data attribute to the corresponding vehicle 20. The request to provide the data attributes may be made from the API management device 50 mounted in the vehicle 20 via communication such as the Internet, or from a terminal mounted in the server 10.

In this case, the valid attribute determination unit 16 acquires a vehicle ID as information identifying the vehicle 20 to which the data attribute is provided together with the data attribute provision request.

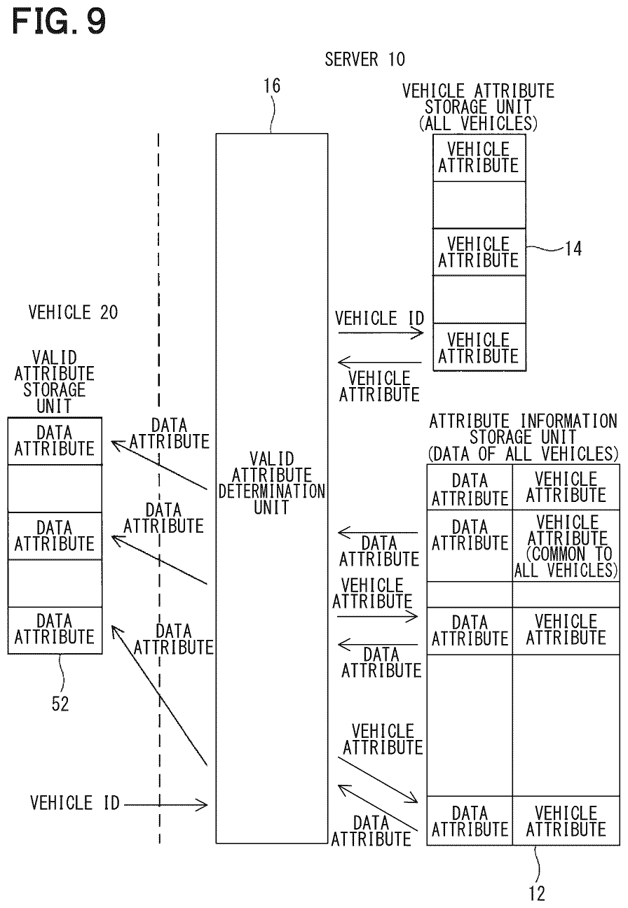

In S2, the valid attribute determination unit 16 refers to the vehicle attributes of all vehicles 20 stored by the vehicle attribute storage unit 14. In S3, as shown in FIG. 9, the valid attribute determination unit 16 acquires the vehicle attribute of the vehicle 20 corresponding to the vehicle ID from the vehicle attributes of all the vehicles 20 stored by the vehicle attribute storage unit 14.

In S4 and S5, as shown in FIG. 9, the valid attribute determination unit 16 refers to the attribute information stored by the attribute information storage unit 12 based on the vehicle attribute acquired in S3 and acquires the attribute information.

In S6, the valid attribute determination unit 16 determines whether the data attribute of the attribute information acquired from the attribute information storage unit 12 is valid for the corresponding vehicle 20. That is, the valid attribute determination unit 16 determines whether the data attribute corresponds to the vehicle attribute acquired from the vehicle attribute storage unit 14, and selects a valid data attribute for the corresponding vehicle 20.

In S7, the valid attribute determination unit 16 provides the selected valid data attribute to the API management device 50.

In S8, the valid attribute storage unit 52 stores and holds valid data attributes in the vehicle 20 provided from the server 10 in a rewritable non-volatile memory such as the flash memory 66.

### (2) Vehicle Data Provision Process

In S10, the application 42 calls the vehicle data by the data name. The data name called by the application 42 is not, for example, a name assigned to each vehicle 20, but a general-purpose name such as water temperature. In S11, the data provision unit 54 refers to the data attributes stored by the valid attribute storage unit 52 based on the data name called by the application 42.

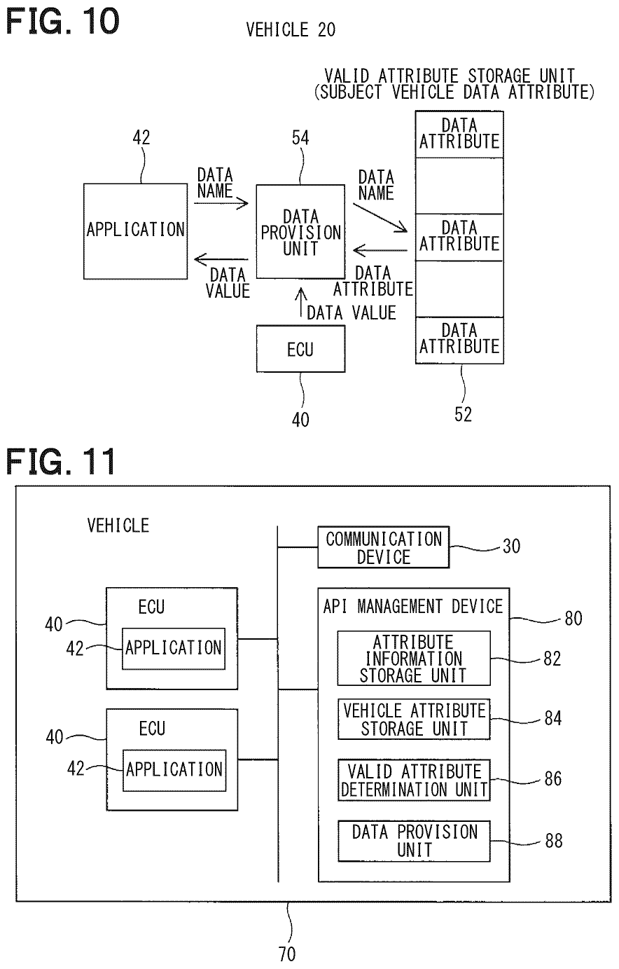

As shown in FIG. 10, in S12, the data provision unit 54 acquires, from the valid attribute storage unit 52, a data attribute having a data name corresponding to the data name called by the application 42 from the referenced data attribute.

In S13, as shown in FIG. 10, the data provision unit 54 acquires the data value corresponding to the data name of the acquired data attribute from the ECU 40 and provides it to the application 42.

In the first embodiment described above, S1 to S7 correspond to the process of the valid attribute determination unit 16 of the server 10, and S11 to S13 correspond to the process of the data provision unit 54 of the API management device 50.

### (1-3. Effects)

The first embodiment described above achieves the following effects.

(1a) Based on the vehicle attributes, the server 10 provides data attributes valid for the vehicle 20 for each vehicle 20 to the API management device 50. Then, when the application 42 calls the vehicle data by the data name, the application 42 can acquire the data value of the vehicle data corresponding to the data name using the API provided by the API management system 2.

For example, even when the data attributes of vehicle data having the same water temperature are different for each vehicle 20, the creator of the application 42 can create the application 42 installed in the vehicle 20 without selecting the water temperature data having the valid data attribute for each vehicle 20 himself. Accordingly, it is possible to shorten the time required to create the application 42 and prevent errors in selecting the vehicle data used by the application 42.

(1b) Since the server 10 stores attribute information of all vehicles 20 and the API management device 50 only needs to store valid data attributes in the vehicle 20 equipped with the API management device 50, it is possible to reduce the amount of data stored by the vehicle 20.

### 2. Second Embodiment

(2-1. Difference from First Embodiment)

The fundamental configuration of a second embodiment is similar to that of the first embodiment. Therefore, the difference therebetween will be described below. The same reference numerals as in the first embodiment denote the same elements, and reference is made to the preceding description.

In the first embodiment described above, the server 10 stores attribute information of all vehicles 20, and the server 10 provides data attributes valid for the vehicle 20, in which the API management device 50 is mounted, to the API management device 50.

The second embodiment shown in FIG. 11 differs from the first embodiment in that an API management device 80 of each vehicle 70 stores attribute information of all vehicles 70 and the API management device 80 selects valid data attributes for the vehicles 70.

The vehicle 70 includes the communication device 30, multiple ECUs 40, and the API management device 80. The vehicle 70 communicates with the server 10 via a network or the like by the communication device 30.

The API management device 80 includes an attribute information storage unit 82, a vehicle attribute storage unit 84, a valid attribute determination unit 86, and a data provision unit 88.

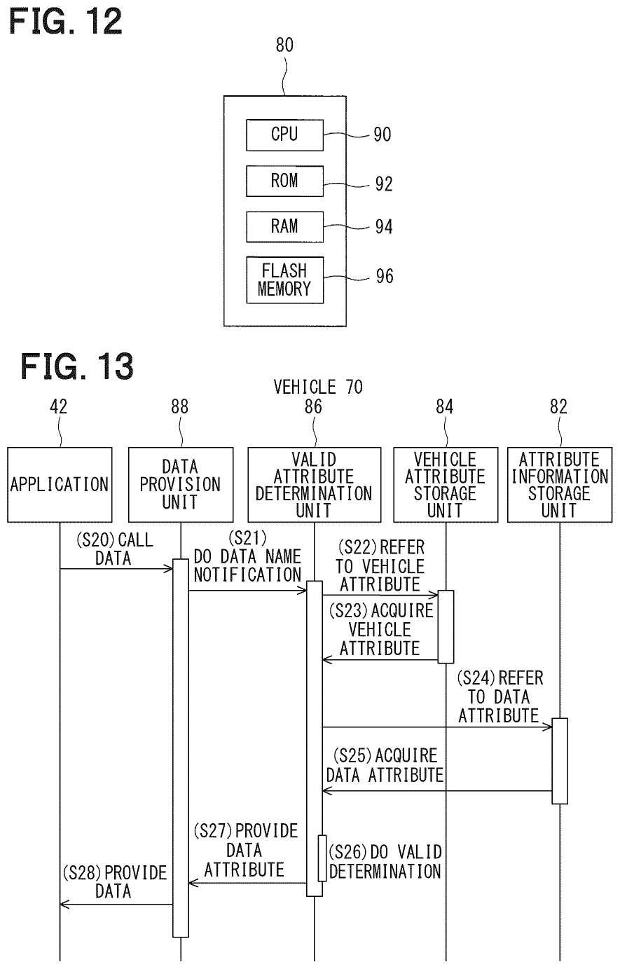

As shown in FIG. 12, the API management device 80 includes a CPU 90, a ROM 92, a RAM 94, a flash memory 96, and the like as a hardware configuration. Various functions of the API management device 80 are implemented by the CPU 90 executing programs stored in a non-transitory tangible storage medium such as the ROM 92. Further, by executing this program, a method corresponding to the program is executed.

The attribute information storage unit 82 of the API management device 80 stores, as multiple vehicles 70, attribute information having the data attributes and the vehicle attributes described in the first embodiment for all vehicles 70 in the world.

When the vehicle attribute or data attribute of the subject vehicle 70 is changed or added, the attribute information stored by the attribute information storage unit 82 of the API management device 80 is changed or added by the dealer or the like. Even when the vehicle attributes or data attributes of the other vehicles 70 are changed or added, the attribute information of the attribute information storage unit 82 of the subject vehicle 70 is not changed or added.

The vehicle attribute storage unit 84 stores the vehicle attributes of the vehicle 70 equipped with the API management device 80.

The valid attribute determination unit 86 determines and provides valid data attributes to be used in the vehicle 70 based on the data name called by the application 42, the vehicle attributes stored by the vehicle attribute storage unit 84, and the attribute information stored by the attribute information storage unit 82.

When the application 42 is executed and calls the data name of the vehicle data, the data provision unit 88 acquires vehicle data in accordance with the data name, for example, from the ECU 40 based on the data attribute provided by the valid attribute determination unit 86 in accordance with the data name, and provides the vehicle data to the application 42.

### (2-2. Process)

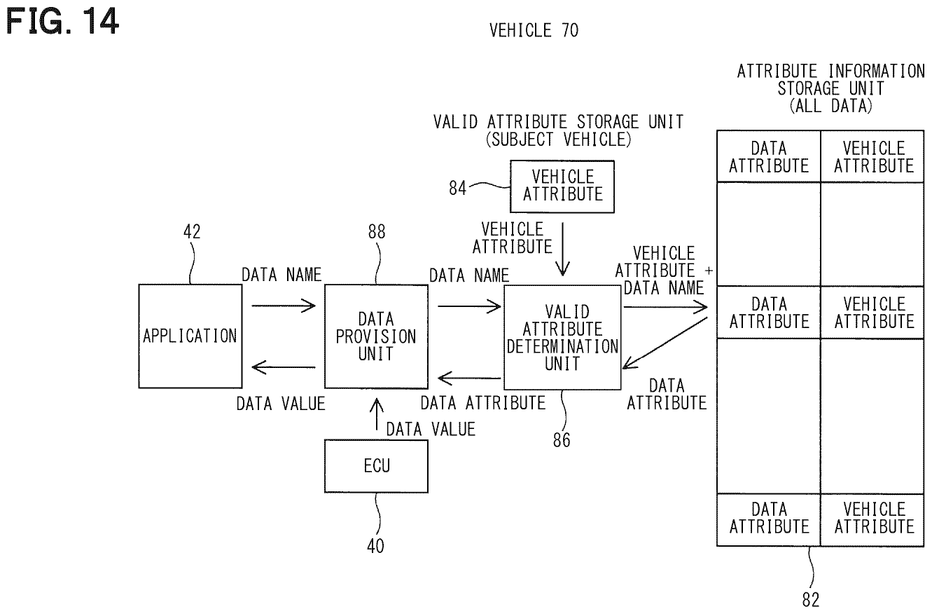

An API management process executed by the API management device 80 will be described with reference to FIGS. 13 and 14.

In S20 of FIG. 13, the application 42 calls the vehicle data by the data name. The data name called by the application 42 is not, for example, a name assigned to each vehicle 70, but a general-purpose name such as water temperature. In S21, the data provision unit 88 notifies the valid attribute determination unit 86 of the data name called by the application 42.

In S22 and S23, the valid attribute determination unit 86 refers to the vehicle attribute storage unit 84, and acquires the vehicle attribute of the subject vehicle 70 from the vehicle attribute storage unit 84.

In S24 and S25, as shown in FIG. 14, the valid attribute determination unit 86 refers to the attribute information stored by the attribute information storage unit 82 based on the vehicle attribute acquired in S23, and acquires the information.

In S26, the valid attribute determination unit 86 determines whether the data attribute of the attribute information acquired from the attribute information storage unit 82 is valid for the subject vehicle 70, that is, whether it is a data attribute corresponding to the vehicle attribute acquired from the vehicle attribute storage unit 84, and selects a valid data attribute for the subject vehicle 70.

In S27, the valid attribute determination unit 16 provides the selected valid data attribute to the data provision unit 88.

In S28, as shown in FIG. 14, the data provision unit 88 acquires the data value corresponding to the data name of the data attribute from the ECU 40 and provides it to the application 42.

In the second embodiment described above, S21 and S28 correspond to the process of the data provision unit 88, and S22 to S27 correspond to the process of the valid attribute determination unit 86.

### (2-3. Effects)

The second embodiment described above achieves the following effects.

(2a) When the application 42 calls the vehicle data by the data name, the application can acquire the data value corresponding to the data name using the API provided by the API management device 80.

For example, even when the data attributes of vehicle data having the same name of water temperature are different for each vehicle 70, the creator of the application 42 can create the application 42 installed in the vehicle 70 without selecting the water temperature data having a valid data attribute for each vehicle 70 himself. Accordingly, it is possible to shorten the time required to create the application 42 and prevent errors in selecting the vehicle data used by the application 42.

(2b) The API management device 80 in the vehicle stores attribute information of all vehicles 70 including the subject vehicle 70 in the attribute information storage unit 82. Accordingly, when the vehicle attribute or data attribute of the subject vehicle 70 is changed or added, the attribute information stored by the attribute information storage unit 82 is changed or added by the dealer or the like.

Accordingly, as compared with the case where the attribute information stored by the API management device 80 is changed or added by communication from the server or the like during traveling, it is possible to prevent the change or addition of the attribute information from being prevented by the communication failure.

### 3. Other Embodiments

Although the embodiments of the present disclosure has been described above, the present disclosure is not limited to the above-described embodiments, and various modifications can be made.

(3a) The server 10 of the first embodiment and the API management device 80 of the second embodiment described above store attribute information of all vehicles 20 and 70 of all vehicle manufacturers as the multiple vehicles 20 and 70.

For example, in the first embodiment, the server 10 of the vehicle manufacturer may store attribute information of all vehicles 20 of the subject manufacturer as multiple vehicles 20, and provide valid data attributes for the vehicles 20 of the subject manufacturer.

Further, in the second embodiment, as the multiple vehicles 70, the API management device 80 may store attribute information of all vehicles 70 of the subject manufacturer for each vehicle manufacturer equipped with the API management device 80, and provide valid data attributes for the subject vehicle 70 equipped with the API management device 80.

(3b) The API management system 2, the API management device 80, and the method thereof described in the present disclosure may be implemented by a dedicated computer provided by configuring a processor and a memory programmed to execute one or multiple functions embodied by a computer program.

Alternatively, the API management system 2 and the API management device 80, and the method thereof described in the present disclosure may be implemented by a dedicated computer including a processor implemented by one or more dedicated hardware logic circuits.

Alternatively, the API management system 2 and the API management device 80 described in the present disclosure, as well as their methods, may be implemented by one or more dedicated computers, each comprising a combination of a processor and memory programmed to execute one or more functions, and one or more processors constituted by hardware logic circuits.

Furthermore, the computer program may be stored in a computer-readable non-transitory tangible storage medium as an instruction executed by the computer. The method for implementing the functions of the respective units included in the API management system 2 and the API management device 80 does not necessarily need to include software, and all of the functions may be implemented with the use of one or multiple hardware.

(3c) The multiple functions of one component in the above embodiments may be implemented by multiple components, or a function of one component may be implemented by multiple components. In addition, multiple functions of multiple components may be implemented by one component, or a single function implemented by multiple components may be implemented by one component. A part of the configuration of the above embodiment may be omitted as appropriate. At least a part of the configuration of the above embodiment may be added to or replaced with another configuration of the above embodiment.

(3d) In addition to the API management system 2 and the API management device 80 described above, the present disclosure can be implemented in various forms such as the system having the API management device 80 as a configuration element, the API management program for causing a computer to function as the API management system 2 and the API management device 80, a non-transitory tangible storage medium such as a semiconductor memory storing the management program, and an API management method.

What is claimed is:

1. An application programing interface management system comprising:
a server; and
an in-vehicle application programing interface management device,
wherein
the server
includes a storage that
stores attribute information that associates a data attribute of vehicle data of each of a plurality of vehicles with a vehicle attribute that identifies the plurality of vehicles having the data attribute, and
stores the vehicle attribute of each vehicle, and
selects the data attribute valid for each vehicle from the attribute information based on the stored attribute information and the stored vehicle attribute, and provides the data attribute to the in-vehicle application programing interface management device, and
the in-vehicle application programing interface management device includes:
a valid attribute storage configured to store the data attribute that is valid and provided from the server in accordance with, among the plurality of vehicles, a vehicle in which the in-vehicle application programing interface management device is mounted; and
at least one of (i) a circuit and (ii) a processor with a memory storing computer program code executable by the processor, the at least one of the circuit and the processor configured to cause the in-vehicle application programing interface management device to select the vehicle data used by an application program installed in the plurality of vehicles based on the data attribute stored by the valid attribute storage, and provide the vehicle data to the application program.

2. The application programing interface management system according to claim 1, wherein
the at least one of the circuit and the processor is further configured to cause the in-vehicle application programing interface management device to select the vehicle data used by the application program based on a data name called by the application program and the data attribute stored by the valid attribute storage, and provide the vehicle data to the application program.

3. The application programing interface management system according to claim 1, wherein
the vehicle attribute includes at least a vehicle manufacturer, a vehicle type, a driving system, a use country, or a grade for at least one of the plurality of vehicles.

4. The application programing interface management system according to claim 1, wherein
when the attribute information is first provided to the vehicle and when at least one of the attribute information or the vehicle attribute is changed, the server selects the data attribute that is valid for the vehicle and provides the data attribute to the in-vehicle application programing interface management device.

5. A non-transitory computer-readable storage medium storing an application programing interface management program installed in a server configured to cause a computer to cause an application programing interface management device, which selects vehicle data used by an application program installed in a plurality of vehicles based on data attribute valid for the plurality of vehicles and provides the vehicle data to the application program, to provide the data attribute valid for the plurality of vehicles, the application programing interface management program causing the computer to:
store attribute information that associates the data attribute of the vehicle data of each of the plurality of vehicles with a vehicle attribute that identifies the plurality of vehicles having the data attribute;
store the vehicle attribute of each vehicle; and
select the data attribute valid for each vehicle from the attribute information based on the stored attribute information and the stored vehicle attribute, and provide the data attribute to the application programing interface management device.

6. A non-transitory computer-readable storage medium storing an application programing interface management program installed in an in-vehicle application programing interface management device, the application programing interface management program causing a computer to:
store a data attribute that is valid for each of a plurality of vehicles, selected from attribute information based on the data attribute of vehicle data of the plurality of vehicles and a vehicle attribute of each vehicle, and provided from a server, wherein the attribute information that associates the data attribute with the vehicle attribute that identifies the plurality of vehicles having the data attribute; and
select and provide the vehicle data used by an application program installed in the plurality of vehicles to the application program based on the stored data attribute.

7. An in-vehicle application programing interface management device comprising:
an attribute information storage configured to store attribute information that associates a data attribute of vehicle data of each of a plurality of vehicles including a subject vehicle with a vehicle attribute that identifies the plurality of vehicles having the data attribute;
a vehicle attribute storage configured to store the vehicle attribute of the subject vehicle; and
at least one of (i) a circuit and (ii) a processor with a memory storing computer program code executable by the processor, the at least one of the circuit and the processor configured to cause the in-vehicle application programing interface management device to:
determine and select the data attribute valid for the subject vehicle from the attribute information based on the attribute information stored by the attribute information storage and the vehicle attribute stored by the vehicle attribute storage; and
select and provide the vehicle data used by an application program installed in the plurality of vehicles to the application program based on the data attribute determined to be valid.

8. The in-vehicle application programing interface management device according to claim 7, wherein
the at least one of the circuit and the processor is further configured to cause the in-vehicle application programing interface management device to select, from the attribute information, the data attribute that is valid for the subject vehicle and is in accordance with a data name based on the data name called by the application program and the vehicle attribute of the vehicle attribute storage.

9. A non-transitory computer-readable storage medium storing an application programing interface management program installed in an in-vehicle application programing interface management device, the application programing interface management program causing a computer to:
store attribute information that associates a data attribute representing an attribute of vehicle data of each of a plurality of vehicles including a subject vehicle with a vehicle attribute that identifies the plurality of vehicles;
store the vehicle attribute of the subject vehicle;
determine and select the data attribute valid for the subject vehicle from the attribute information based on the stored attribute information and the stored vehicle attribute; and
select and provide the vehicle data used by an application program installed in the plurality of vehicles to the application program based on the data attribute determined to be valid.
